(19) United States
(12) Patent Application Publication
(10) Pub. No.: US 2025/0307035 A1
(43) Pub. Date: Oct. 2, 2025

(54) COMPUTER-READABLE RECORDING MEDIUM STORING TASK TUNING PROGRAM AND TASK TUNING METHOD

(71) Applicant: Fujitsu Limited, Kawasaki-shi (JP)

(72) Inventor: Keisuke TSUGANE, Kawasaki (JP)

(73) Assignee: Fujitsu Limited, Kawasaki-shi (JP)

(21) Appl. No.: 19/047,788

(22) Filed: Feb. 7, 2025

(30) Foreign Application Priority Data
Mar. 26, 2024 (JP) 2024-050558

(51) Int. Cl. G06F 9/52

(52) U.S. Cl. CPC G06F 9/52

(57) ABSTRACT

A recording medium stores a program for causing a computer to execute a process including: analyzing a program and detecting tasks; identifying pairs of tasks that are able to be fused into one task among the tasks that have been detected based on a dependency relationship between the tasks; for each of the pairs, calculating theoretical peak computational performance in a case where tasks of the pairs are fused based on a first value that represents a memory bandwidth per computational performance when tasks of the pairs are fused, a second value that represents a memory bandwidth per computational performance of hardware that executes the program, and computational performance of the hardware; determining a fusion target pair from the pairs that have been identified based on the theoretical peak computational performance that has been calculated; and fusing tasks of the fusion target pair that has been determined in the program.

### CROSS-REFERENCE TO RELATED APPLICATION

This application is based upon and claims the benefit of priority of the prior Japanese Patent Application No. 2024-50558, filed on Mar. 26, 2024, the entire contents of which are incorporated herein by reference.

### FIELD

The embodiment discussed herein is related to a computer-readable recording medium storing a task tuning program and a task tuning method.

### BACKGROUND

In related art, as one of programming techniques in a distributed memory environment, there is task parallelism with data dependency. As an execution form of task parallelism with data dependency, for example, there is a form in which a thread corresponding to a core in a node is generated and a task is executed in the thread. On the other hand, with the advent of various types of hardware in recent years, programming tailored for the characteristics of hardware is desired for speeding up a program.

International Publication Pamphlet No. WO 2018-158819 is disclosed as related art.

### SUMMARY

According to an aspect of the embodiments, a non-transitory computer-readable recording medium stores a task tuning program for causing a computer to execute a process including: analyzing a program and detecting tasks; identifying pairs of tasks that are able to be fused into one task among the tasks that have been detected based on a dependency relationship between the tasks that have been detected; for each of the pairs that have been identified, calculating theoretical peak computational performance in a case where tasks of the pairs are fused based on a first value that represents a memory bandwidth per computational performance in a case where tasks of the pairs are fused, a second value that represents a memory bandwidth per computational performance of hardware that executes the program, and computational performance of the hardware; determining a fusion target pair from the pairs that have been identified based on the theoretical peak computational performance that has been calculated; and fusing tasks of the fusion target pair that has been determined in the program.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an exemplary embodiment of a task tuning method according to an embodiment;

FIG. 2 is an explanatory diagram illustrating an example of a program of description for task parallelism with data dependency;

FIG. 3 is a block diagram illustrating a hardware configuration example of an information processing device;

FIG. 4 is a block diagram illustrating a functional configuration example of the information processing device;

FIG. 5 is an explanatory diagram illustrating a specific example of a target program;

FIG. 6 is an explanatory diagram illustrating a specific example of a task flow;

FIG. 7 is an explanatory diagram illustrating a calculation example of theoretical peak computational performance (part 1);

FIG. 8 is an explanatory diagram illustrating a calculation example of theoretical peak computational performance (part 2);

FIG. 9 is an explanatory diagram illustrating a fusion example of tasks;

FIG. 10 is an explanatory diagram illustrating an update example of the task flow;

FIG. 11 is a flowchart illustrating an example of a task tuning processing procedure of the information processing device (part 1); and

FIG. 12 is a flowchart illustrating an example of the task tuning processing procedure of the information processing device (part 2).

### DESCRIPTION OF EMBODIMENTS

For example, there is related art in which when a task is executed using a plurality of computing devices, an amount of data to be processed by a processing instruction of the task is distributed among the plurality of computing devices according to a difference in computing capability between the plurality of computing devices, and the task is distributed and executed using the plurality of computing devices.

However, with related art, it is difficult to speed up a program of description for task parallelism with data dependency or the like. For example, in a case where rewriting of a program tailored for the characteristics of hardware is manually performed in the advent of various types of hardware, there is a problem of causing an increase in cost for implementation and maintenance.

In one aspect, it is an object of the present disclosure to achieve speeding up of a program.

With reference to the drawings, an embodiment of a task tuning program and a task tuning method according to the present disclosure will be described in detail below.

### EMBODIMENT

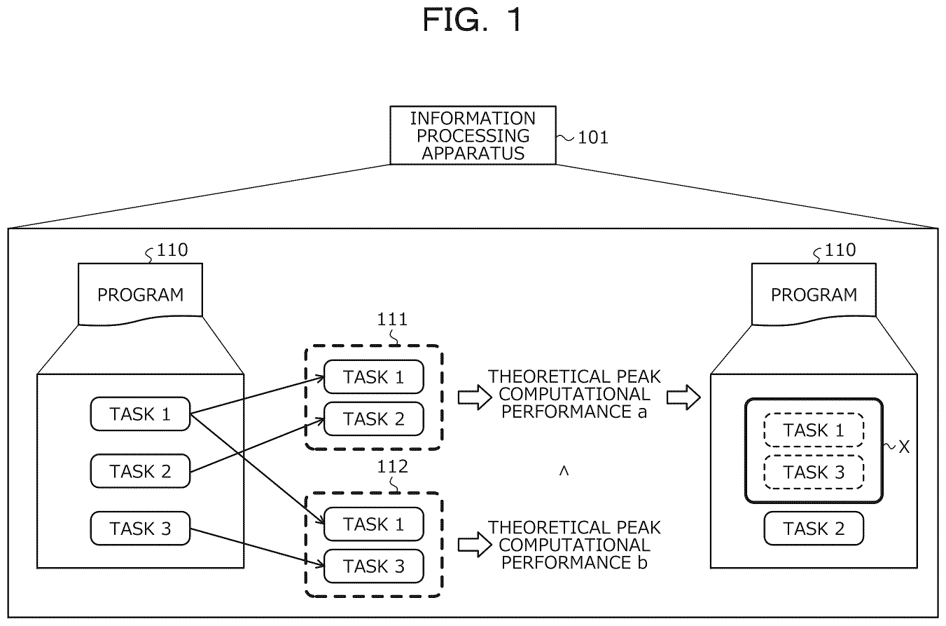

FIG. 1 is an explanatory diagram illustrating an exemplary embodiment of the task tuning method according to the embodiment. In FIG. 1, an information processing device 101 is a computer that controls execution of a program. For example, the information processing device 101 is a personal computer (PC). The information processing device 101 may be a server.

For example, a program to be executed is a program of description for task parallelism with data dependency. Description for task parallelism with data dependency is description for executing tasks in parallel by converting computation into a task and explicitly describing read/write of data used in the task. A task is an execution unit of a program.

For example, in task parallelism with data dependency by open multi-processing (OpenMP), tasks are executed in parallel based on data dependency description (in, out) between the tasks. OpenMP is an application programming interface (API) that enables parallel programming in a shared memory type machine.

By describing input and output processing (in, out) in a task, a dependency relationship such as flow dependency, inverse flow dependency, and output dependency occur. Flow dependency refers to subsequent reading of written data (out→in). Inverse flow dependency is the opposite of flow dependency, and refers to writing after reading (in→out). Output dependency refers to writing of another value after writing (out→out).

When there is any dependency relationship based on data dependency of flow dependency, inverse flow dependency, or output dependency between tasks, the tasks may not be executed in parallel. For this reason, in related art, a runtime of a compiler schedules a task based on the description of input and output processing (in, out) in the task, and executes the task in each thread. A compiler is a translation program that converts a program described in a high-level language into a machine language that may be directly interpreted and executed by a computer. A runtime is a component (function) for executing a program.

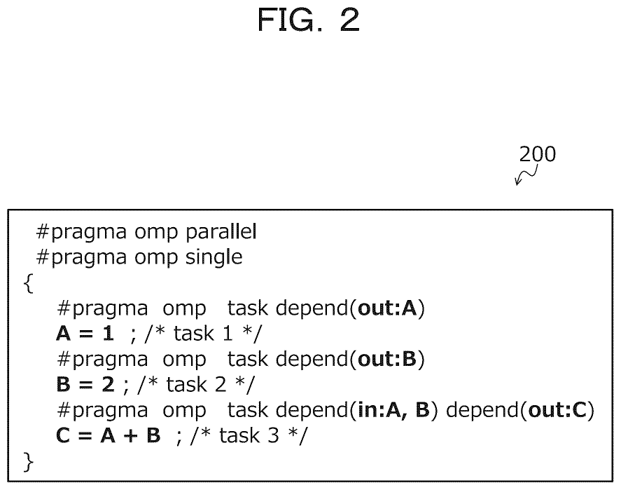

With reference to FIG. 2, an example of a program of description for task parallelism with data dependency will be described. In OpenMP, a task is described using a directive for compiler called pragma directive (#pragma).

FIG. 2 is an explanatory diagram illustrating an example of a program of description for task parallelism with data dependency. In FIG. 2, a program 200 is an example of a program implemented by description for task parallelism with data dependency. depend is a directive clause for describing input and output processing (in, out) in a task.

In the program 200, task1 is out: A since writing is performed for variable A. task2 is out: B since writing is performed for variable B. task3 is in: A, B since variables A and B are read, and is out: C since writing is performed for variable C.

For example, in the program 200, task1 and task2 are executed in parallel since there is no dependency relationship between task1 and task2. On the other hand, task3 is executed after task1 and task2 are completed since it has flow dependency on task1 and task2.

As described above, by a user describing the data dependency between tasks, the runtime schedules the tasks based on the dependency relationship and overall synchronization is changed to synchronization between tasks, whereby speeding up of a program is achieved.

Meanwhile, programming tailored for characteristics such as computational performance and a memory bandwidth of hardware is desired for speeding up a program. However, with the advent of various types of hardware in recent years, manual rewriting of a program tailored for the characteristics of individual hardware leads to an increase in cost for implementation and maintenance.

In the present embodiment, a task tuning method will be described in which speeding up of a program is achieved by automatic tuning of the program tailored for the characteristics of the executing hardware (for example, the information processing device 101). A processing example of the information processing device 101 will be described. A program to be executed is referred to as a “program 110”. For example, the program 110 is a program for high performance computing (HPC) (such as an application).

(1) The information processing device 101 analyzes the program 110 and detects tasks. For example, the information processing device 101 analyzes the program 110 and identifies task directives. A task directive is a directive for generating a task. The information processing device 101 detects a task corresponding to each identified task directive from the program 110.

In the example of FIG. 1, a case is assumed in which task 1, task 2, and task 3 are detected from the program 110.

(2) The information processing device 101 identifies pairs of tasks that may be fused into one task among the detected tasks based on the dependency relationship between detected tasks. The dependency relationship between tasks is a relationship based on data dependency such as flow dependency, inverse flow dependency, and output dependency. For example, the dependency relationship between tasks may be identified by dependency analysis of the program 110 by a compiler.

Fusion of tasks refers to collectively treating two tasks as one task. Fusion of tasks is performed so as not to strain the dependency relationship between tasks. For example, in a case where task 2 is fused with task 1 in the program 110, the task details of the program 110 is changed such that the processing of task 1 is executed and then the processing of task 2 is executed in one task.

In a case where there is no dependency relationship between task 1 and task 2 when such fusion is performed, it may be said that task 1 and task 2 may be fused. In a case where there is output dependency between task 1 and task 2, it may be said that task 1 and task 2 may be fused unless the execution order is changed since task 1 and task 2 are executed in this order in the task after fusion even when task 2 is fused with task 1.

For example, the information processing device 101 creates a task flow based on the dependency relationship between detected tasks. A task flow is graph information in which detected tasks are arranged in an execution order that satisfies the dependency relationship between tasks and the tasks having a dependency relationship are coupled to each other.

Describing in more detail, for example, the information processing device 101 selects an unselected first task that has not been selected from the top of the task flow. By selecting, from the task flow, a second task that is after the selected first task and that may be fused with the first task, the information processing device 101 identifies the pair of the selected first task and second task.

In the example of FIG. 1, a case is assumed in which a pair 111 and a pair 112 are identified as pairs of tasks that may be fused into one task. The pair 111 is the pair of task 1 and task 2 among the detected tasks 1, 2, and 3. The pair 112 is the pair of task 1 and task 3 that may be fused into one task among the detected tasks 1, 2, and 3.

(3) For each identified pair, the information processing device 101 calculates theoretical peak computational performance in a case where the tasks of the pair are fused. Theoretical peak computational performance is calculated based on a first value representing a memory bandwidth per computational performance in a case where a pair of tasks are fused, a second value representing a memory bandwidth per computational performance of hardware, and the computational performance of hardware.

Hardware is hardware that executes the program 110 (execution environment), and is, for example, the information processing device 101. Memory bandwidth per computational performance is an indicator for evaluating performance. The first value corresponds to an indicator value for evaluating the performance of a task after fusion in which a pair of tasks are fused. The second value corresponds to an indicator value for evaluating the performance of hardware. The computational performance of hardware is an indicator representing the performance of hardware, and is represented by, for example, gigaflops (GFLOPS).

For example, a memory bandwidth per computational performance is a byte (B)/flop (F) ratio. B/F ratio is a kind of performance indicator of an application or hardware. In the case of an application, it may be said that the memory bandwidth is a bottleneck when the B/F ratio is high, and the computational performance is a bottleneck when the B/F ratio is low. In the case of hardware, it may be said that the memory bandwidth is wide when the B/F ratio is high, and the computational performance is high when the B/F ratio is low. When the B/F ratios of an application and hardware are close to each other, it may be said theoretically that the performance of the hardware is brought out.

As an indicator for evaluating the performance of a task after fusion in which a pair of tasks are fused, memory bandwidth per computational performance (for example, B/F ratio) is used. The information processing device 101 calculates theoretical peak computational performance in a case where tasks are fused by considering how much the computational performance of hardware is brought out from the closeness between the first value and the second value.

In the example of FIG. 1, a case is assumed in which “theoretical peak computational performance a” is calculated as the theoretical peak computational performance in a case where task 1 and task 2 of the pair 111 are fused. A case is assumed in which “theoretical peak computational performance b” is calculated as the theoretical peak computational performance in a case where task 1 and task 3 of the pair 112 are fused.

(4) The information processing device 101 determines a fusion target pair from the identified pairs based on the calculated theoretical peak computational performance. For example, the information processing device 101 determines, as the fusion target pair, a pair having the highest calculated theoretical peak computational performance from the identified pairs.

In the example of FIG. 1, theoretical peak computational performance b is higher than theoretical peak computational performance a. In this case, for example, the information processing device 101 determines, as the fusion target pair, the pair 112 having the highest theoretical peak computational performance from the identified pairs 111 and 112.

(5) The information processing device 101 fuses the tasks of the determined fusion target pair in the program 110. In the example of FIG. 1, the information processing device 101 fuses task 1 and task 3 of the fusion target pair 112. For example, the information processing device 101 changes the task details of the program 110 such that task 1 is executed and then task 3 is executed in one task X, by fusing task 3 with task 1.

As described above, according to the information processing device 101, speeding up of the program 110 may be achieved by automatic tuning of the program 110 tailored for the characteristics of the executing hardware (for example, the information processing device 101). According to the information processing device 101, since manual rewriting of a program tailored for the characteristics of individual hardware does not have to be performed, an increase in cost for implementation and maintenance may be suppressed.

In the example of FIG. 1, the information processing device 101 may improve the performance of the program 110 by grouping tasks 1 and 3, the performance of which is expected to be improved by task fusion, into one task X. For example, by grouping tasks 1 and 3 into one task X, information may be reused in task X and an extra number of times of load is reduced, and improvement in performance may be expected.

### (Hardware Configuration Example of Information Processing Device 101)

Next, a hardware configuration example of the information processing device 101 will be described.

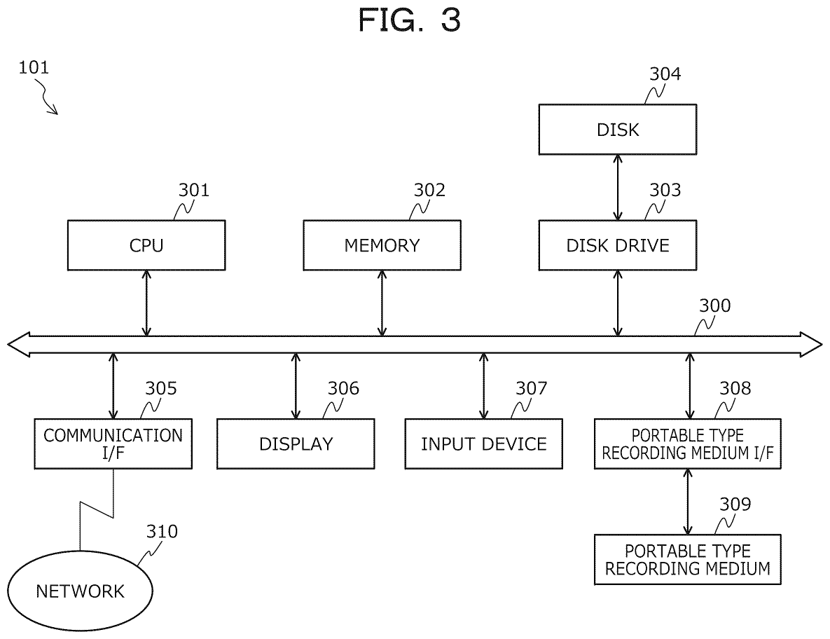

FIG. 3 is a block diagram illustrating a hardware configuration example of the information processing device 101. In FIG. 3, the information processing device 101 includes a central processing unit (CPU) 301, a memory 302, a disk drive 303, a disk 304, a communication interface (I/F) 305, a display 306, an input device 307, a portable type recording medium I/F 308, and a portable type recording medium 309. These constituent units are coupled to each other by a bus 300.

The CPU 301 controls the entirety of the information processing device 101. The CPU 301 may include a plurality of cores. For example, the memory 302 includes a read-only memory (ROM), a random-access memory (RAM), and the like. A program stored in the memory 302 causes the CPU 301 to execute the coded processing by being loaded into the CPU 301.

The disk drive 303 controls reading and writing of data from and to the disk 304 in accordance with the control of the CPU 301. The disk 304 stores data written under the control of the disk drive 303. For example, the disk 304 is a magnetic disk, an optical disk, or the like.

The communication I/F 305 is coupled to a network 310 through a communication line and coupled to an external computer via the network 310. The communication I/F 305 functions as an interface between the network 310 and the inside of the device, and controls input and output of data from and to the external computer. For example, the network 310 is the Internet, a local area network (LAN), a wide area network (WAN), or the like. For example, the communication I/F 305 is a modem, a LAN adapter, or the like.

The display 306 is a display device that displays data such as a document, an image, and function information, including a cursor, an icon and a tool box. For example, the display 306 is a liquid crystal display, an organic electroluminescence (EL) display, or the like.

The input device 307 includes keys for inputting letters, numbers, various instructions, and the like, and inputs data. The input device 307 may be a keyboard, a mouse, or the like, or may be a touch panel type input pad, a numeric keypad, or the like.

The portable type recording medium I/F 308 controls reading and writing of data from and to the portable type recording medium 309 in accordance with the control of the CPU 301. The portable type recording medium 309 stores data written under the control of the portable type recording medium I/F 308. For example, the portable type recording medium 309 is a compact disc (CD)-ROM, a Digital Versatile Disk (DVD), a Universal Serial Bus (USB) memory, or the like.

Of the above-described constituent units, for example, the information processing device 101 does not have to include the disk drive 303, the disk 304, the portable type recording medium I/F 308, and the portable type recording medium 309.

### (Functional Configuration Example of Information Processing Device 101)

Next, a functional configuration example of the information processing device 101 will be described.

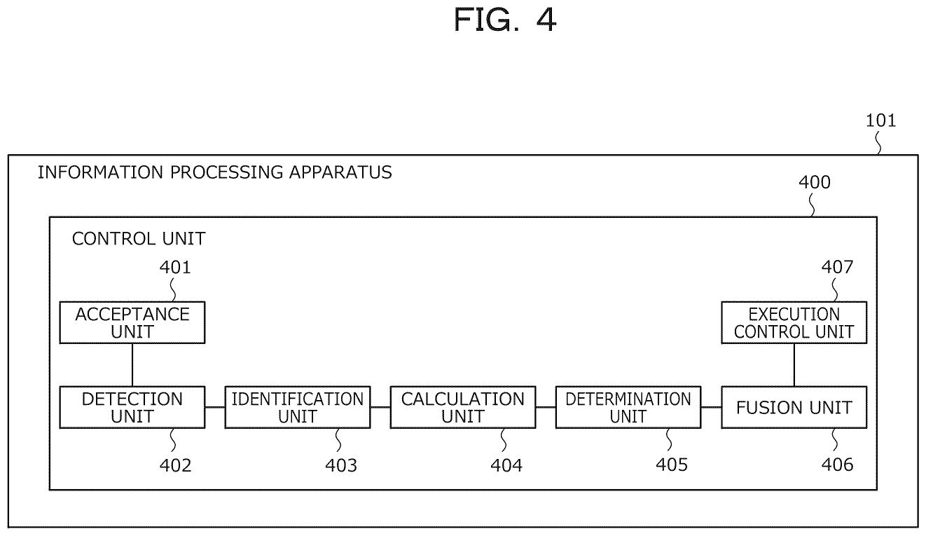

FIG. 4 is a block diagram illustrating a functional configuration example of the information processing device 101. In FIG. 4, the information processing device 101 includes an acceptance unit 401, a detection unit 402, an identification unit 403, a calculation unit 404, a determination unit 405, a fusion unit 406, and an execution control unit 407. The acceptance unit 401 to the execution control unit 407 are functions serving as a control unit 400. For example, the functions are realized by causing the CPU 301 to execute a program stored in a storage device such as the memory 302, the disk 304, or the portable type recording medium 309 illustrated in FIG. 3, or by the communication I/F 305. For example, a processing result of each functional unit is stored in a storage device such as the memory 302 or the disk 304. For example, the functional units (the acceptance unit 401 to the execution control unit 407) of the information processing device 101 may be realized by a compiler.

The acceptance unit 401 accepts a program to be executed. For example, the program to be executed is a program of description for task parallelism with data dependency and is a program for HPC using OpenMP. For example, the acceptance unit 401 accepts the program to be executed by operation input of a user using the input device 307 illustrated in FIG. 3. The acceptance unit 401 may accept the program to be executed by reception from an external computer through the communication I/F 305.

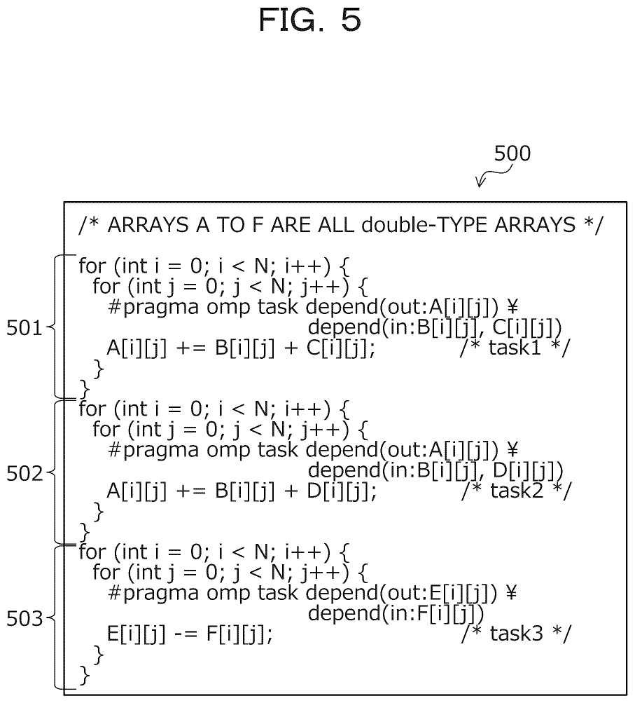

In the following description, there are cases in which the program to be executed is referred to as the “target program”. A specific example of the target program will be described later with reference to FIG. 5.

The detection unit 402 analyzes the target program and detects tasks. For example, the detection unit 402 analyzes the target program and identifies task directives from the target program. A task directive is a directive for generating a task. For example, in the case of OpenMP, the task directive is “#pragma omp task”. The detection unit 402 detects a task corresponding to each identified task directive from the target program.

A detection example of tasks will be described later with reference to FIG. 5.

The identification unit 403 identifies pairs of tasks that may be fused into one task among the detected tasks based on the dependency relationship between detected tasks. For example, the dependency relationship between tasks is a relationship based on data dependency such as flow dependency, inverse flow dependency, and output dependency. Tasks that may be fused is a pair of tasks in which no dependency relationship is strained when the tasks are fused.

For example, the identification unit 403 analyzes the dependency relationship between detected tasks by dependency analysis of the target program by a compiler. Next, the identification unit 403 creates a task flow based on the dependency relationship between tasks. A task flow is information representing the order in which detected tasks are executed.

For example, a task flow is graph information (directed graph) in which detected tasks are arranged in an execution order that satisfies the dependency relationship between tasks and the tasks having the dependency relationship are coupled to each other. The identification unit 403 identifies pairs of tasks that may be fused into one task among the detected tasks based on the created task flow.

Describing in more detail, for example, the identification unit 403 selects an unselected first task that has not been selected from the top of the task flow. Next, the identification unit 403 selects, from the task flow, a second task that is after the selected first task and that may be fused with the first task, based on the dependency relationship between tasks.

When the second task that may be fused with the first task is selected, the identification unit 403 determines whether the first task and the second task may be fused in consideration of not only the dependency relationship between the first task and the second task but also the dependency relationship between other tasks. The identification unit 403 identifies the pair of the selected first task and second task.

For example, selection of the second task may be repeated for the selected first task until there is no unselected second task that has not been selected after the first task. Consequently, pairs of tasks that may be fused are identified for the selected first task. For example, selection of the first task may be repeated until there is no unselected first task that has not been selected from the task flow.

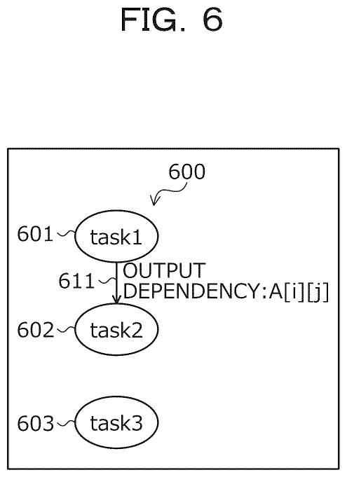

A specific example of a task flow and an identification example of pairs of tasks that may be fused will be described later with reference to FIG. 6.

In the following description, there are cases in which pairs identified for a certain task (first task) in the target program is referred to as “pairs P1 to Pn” (n is a natural number of 1 or larger). There are cases in which an arbitrary pair in the pairs P1 to Pn is referred to as “Pi” (i=1, 2, . . . , n).

For each identified pair Pi, the calculation unit 404 calculates theoretical peak computational performance in a case where the tasks of the pair Pi are fused based on the B/F ratio in the case where the tasks of the pair Pi are fused, the B/F ratio of hardware, and the computational performance of hardware. Hardware is hardware that executes the target program, and is, for example, the information processing device 101 (CPU 301).

The B/F ratio in the case where the tasks of the pair Pi are fused corresponds to the first value representing a memory bandwidth per computational performance in the case where the tasks of the pair Pi are fused. For example, the B/F ratio in the case where the tasks of the pair Pi are fused is identified from the processing details of each task of the pair Pi in the target program.

The B/F ratio of hardware corresponds to the second value representing a memory bandwidth per computational performance of hardware. For example, the computational performance of hardware is double-precision computational performance, and is represented by GFLOPS. For example, the B/F ratio of hardware and the computational performance of hardware are stored in advance in a storage device such as the memory 302 or the disk 304.

For example, the calculation unit 404 may calculate theoretical peak computational performance in the case where the tasks of the pair Pi are fused using the following formula (1). Note that Hardware B/F indicates the B/F ratio of hardware. Task B/F indicates the B/F ratio in the case where the tasks of the pair Pi are fused. Computational Performance [GFLOPS] indicates the computational performance of hardware.

$$\frac{Hardware B / F}{Task B / F} \times Computational Performance [ G F L O P S ] \qquad ( 1 )$$

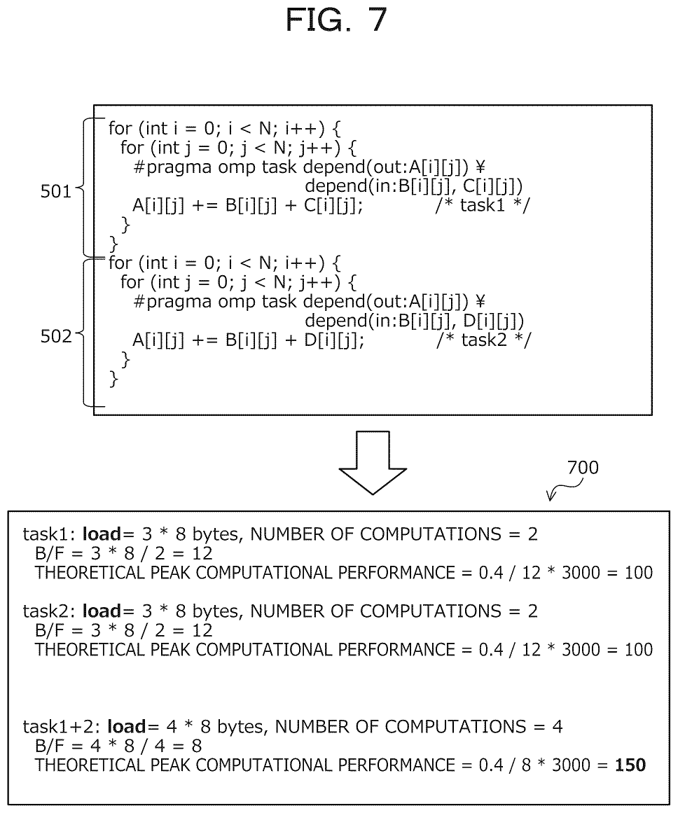

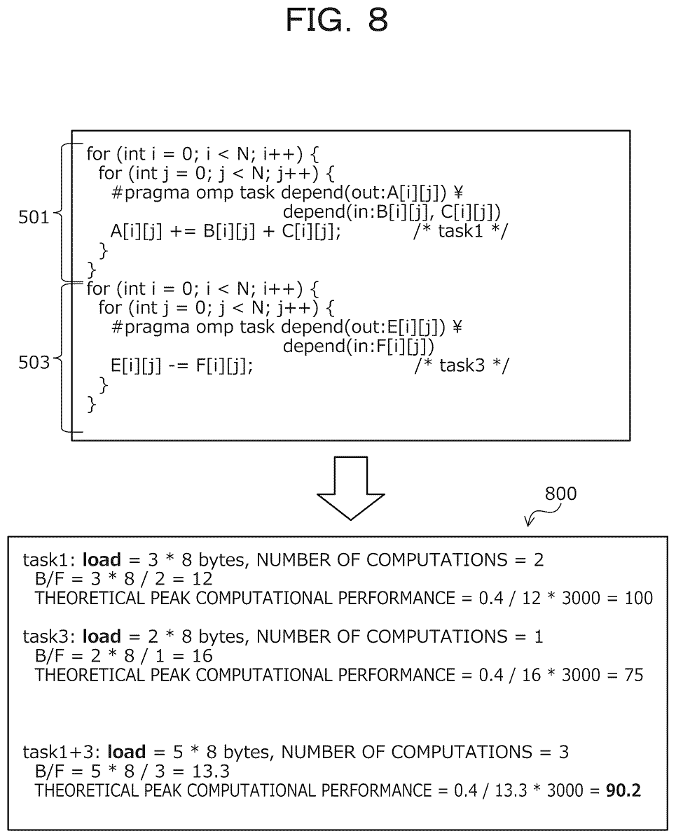

Consequently, theoretical peak computational performance in the case where the tasks of each pair Pi included in the pairs P1 to Pn are fused is calculated. Calculation examples of theoretical peak computational performance in the case where the tasks of the pair Pi are fused will be described later with reference to FIGS. 7 and 8.

The determination unit 405 determines a fusion target pair from the identified pairs P1 to Pn based on the calculated theoretical peak computational performance of each pair Pi. A fusion target pair is a pair to be fused. For example, the determination unit 405 determines, as the fusion target pair, a pair having the highest calculated theoretical peak computational performance from the pairs P1 to Pn.

The fusion unit 406 fuses the tasks of the determined fusion target pair in the target program. For example, the fusion unit 406 updates the target program such that the two tasks of a fusion target pair in the target program are collectively treated as one task. For example, the two tasks of a fusion target pair are fused such that the tasks are sequentially executed internally without a dependency relationship being strained. For example, the fusion unit 406 changes the task details of the target program such that the first task is executed and then the second task is executed in one task by fusing the second task with the first task of the fusion target pair.

In the case where the tasks of a fusion target pair are fused, the fusion unit 406 may update the task flow so that the dependency relationship between tasks is satisfied. For example, the fusion unit 406 updates the task flow by setting the position of a task after fusion in which the first task and the second task of a fusion target pair are grouped in the task flow to the position of either the first task or the second task so that the dependency relationship between tasks is satisfied.

There is a case in which there is a dependency relationship between a certain task in a task after fusion and another task outside the task after fusion. In this case, for example, the task after fusion and the other task are coupled in the task flow based on the dependency relationship.

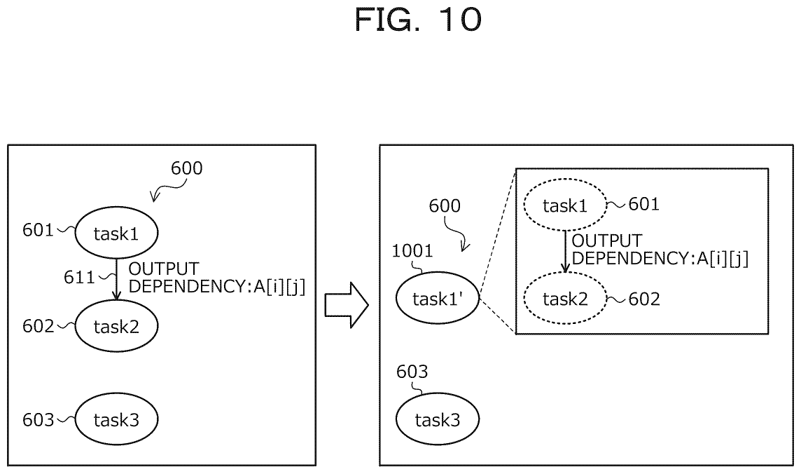

An update example of a task flow will be described later with reference to FIG. 10.

In the case where the task flow is updated, the identification unit 403 may identify a pair of tasks that may be fused into one task among the detected tasks based on the updated task flow. Consequently, there is a case in which the task after fusion is selected as the first task or the second task and is further fused with another task.

In the case where the tasks of a fusion target pair are fused, the identification unit 403 may re-create a task flow based on the target program in which the tasks of the fusion target pair are fused. In this case, the identification unit 403 may identify pairs of tasks that may be fused into one task among the detected tasks based on the re-created task flow.

The calculation unit 404 may calculate theoretical peak computational performance of each task based on the B/F ratio of each task of the determined fusion target pair (third value representing a memory bandwidth per computational performance of each task), the B/F ratio of hardware (second value), and the computational performance of hardware.

For example, the calculation unit 404 may calculate theoretical peak computational performance of each task of the pair Pi using the above formula (1). Note that Task B/F indicates the B/F ratio of each task of the pair Pi. For example, the B/F ratio of each task is identified from the processing details of each task in the target program.

The fusion unit 406 may determine whether the theoretical peak computational performance of a fusion target pair is equal to or lower than the highest theoretical peak computational performance of the calculated theoretical peak computational performances of the tasks of the fusion target pair. When the performance is equal to or lower than the highest theoretical peak computational performance, the fusion unit 406 may choose not to fuse the tasks of the fusion target pair.

For example, when the theoretical peak computational performance of the fusion target pair is higher than the theoretical peak computational performance of any task of the fusion target pair, the fusion unit 406 may fuse the tasks of the fusion target pair. Consequently, the fusion unit 406 may choose not to fuse the tasks of the fusion target pair in a case where improvement in performance by task fusion is not expected.

The fusion unit 406 may determine whether the number of registers to be used in the case where the tasks of the fusion target pair are fused exceeds the number of registers included in hardware. When the number exceeds the number of registers included in hardware, the fusion unit 406 may choose not to fuse the tasks of the fusion target pair.

For example, when the number of registers to be used in the case where the tasks of the fusion target pair are fused is equal to or smaller than the number of registers included in hardware, the fusion unit 406 may fuse the tasks of the fusion target pair. For example, the number of registers included in hardware is stored in advance in a storage device such as the memory 302 or the disk 304.

When the fusion unit 406 has determined that the number of registers to be used in the case where the tasks of the fusion target pair are fused exceeds the number of registers included in hardware, the determination unit 405 may redetermine the fusion target pair from the pairs P1 to Pn. For example, a pair having the highest theoretical peak computational performance is determined as the fusion target pair. In this case, the determination unit 405 may determine, as the fusion target pair, a pair having the second highest calculated theoretical peak computational performance (second highest pair) from the pairs P1 to Pn.

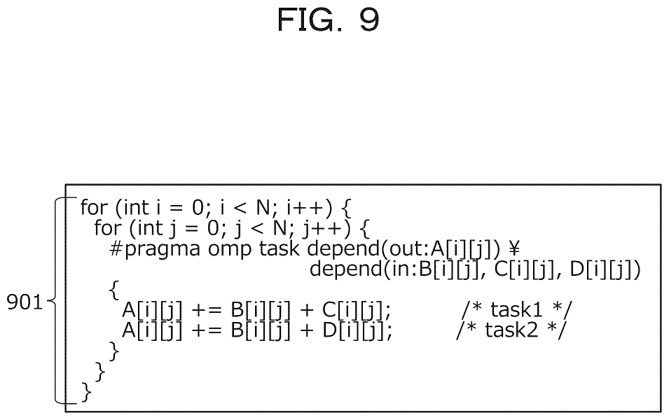

A fusion example of tasks will be described later with reference to FIG. 9.

The execution control unit 407 executes the target program in which the tasks of the fusion target pair are fused. For example, the execution control unit 407 creates an execution file by converting the target program in which the tasks of the fusion target pair are fused into object code, and executes the created execution file.

The execution control unit 407 may output the target program in which the tasks of the fusion target pair are fused. Examples of the output form include storage in a storage device such as the memory 302 or the disk 304, transmission to another computer through the communication I/F 305, and the like.

For example, the execution control unit 407 may transmit the target program in which the tasks of the fusion target pair are fused to another computer via the network 310. Consequently, the target program in which the tasks of the fusion target pair are fused may be executed in the other computer.

The functional units of the information processing device 101 (the acceptance unit 401 to the execution control unit 407) may be realized by a server coupled to the information processing device 101 via the network 310. In this case, the information processing device 101 may execute the target program in which the tasks of a fusion target pair are fused in the own device by receiving the target program in which the tasks of a fusion target pair are fused from the server. The functional units of the information processing device 101 (the acceptance unit 401 to the execution control unit 407) may be realized by a plurality of computers (for example, a PC and a server). In this case, for example, exchange between functional units of different computers is performed by transmission and reception between the functional units via the network 310.

### Specific Example of Target Program

Next, with reference to FIG. 5, a specific example of the target program will be described. While the granularity of a task such as a loop unit or a loop to which tiling is applied may be increased in an actual program, processing in a loop is regarded as one task for simplified description.

FIG. 5 is an explanatory diagram illustrating a specific example of the target program. In FIG. 5, a target program 500 is a program of description for task parallelism with data dependency by OpenMP. The directive of OpenMP is described by pragma (#pragma) and takes such form as “#pragma omp . . .”.

For example, “#pragma omp task” is a directive for designating a task. task1, task2, and task3 are identifiers for identifying tasks. depend is a directive clause for describing input and output processing (in, out) in the task.

In the target program 500, task1 is out: A since writing is performed for array A, and is in: B, C since arrays B and Care read. task2 is out: A since writing is performed for array A, and is in: B, D since arrays B and D are read. task3 is out: E since writing is performed for array E, and is in: F since array F is read. Arrays A to F are all double-type arrays.

A detection example of tasks will be described.

The detection unit 402 analyzes the target program 500 and identifies task directives (#pragma omp task) from the target program 500. The detection unit 402 detects a task corresponding to each identified task directive from the target program 500. task1 to task3 are detected. In the target program 500, description 501 corresponds to task1. Description 502 corresponds to task2. Description 503 corresponds to task3.

### Specific Example of Task Flow

Next, with reference to FIG. 6, a specific example of a task flow will be described. A task flow created based on the target program 500 illustrated in FIG. 5 will be described as an example.

FIG. 6 is an explanatory diagram illustrating a specific example of a task flow. In FIG. 6, a task flow 600 is a directed graph in which tasks (task1 to task3) detected by analyzing the target program 500 (see FIG. 5) are arranged in an execution order that satisfies the dependency relationship between tasks and the tasks having the dependency relationship are coupled to each other.

For example, the identification unit 403 creates the task flow 600 by arranging the detected tasks (task1 to task3) in an appearance order in the target program 500 and coupling the tasks having a dependency relationship. The task flow 600 includes nodes 601 to 603. The node 601 represents task1. The node 602 represents task2. The node 603 represents task3.

There is a dependency relationship of output dependency between task1 and task2. For this reason, the node 601 and the node 602 are coupled by an edge 611 (an arrow directed from the node 601 to the node 602). The edge 611 indicates that there is output dependency of array A [i][j] between task1 and task2.

An identification example of pairs of tasks that may be fused will be described.

For example, the identification unit 403 selects unselected task1 (first task) that has not been selected from the top of the task flow 600. Next, the identification unit 403 selects, from the task flow 600, a second task that is after the selected task1 and that may be fused with task1. In the task flow 600, tasks after task1 are task2 and task3.

While there is output dependency of array A [i][j]between task1 and task2, the tasks may be fused unless the execution order of “task1→task2” is not changed. For this reason, the identification unit 403 selects task2 (second task) that may be fused with task1. The identification unit 403 identifies the pair P1 of the selected task1 and task2.

Since there is no dependency relationship between task1 and task3, the tasks may be fused. For this reason, the identification unit 403 selects task3 (second task) that may be fused with task1. The identification unit 403 identifies the pair P2 of the selected task1 and task3. In the example of the task flow 600, the pairs for task1 (first task) are the pairs P1, P2.

### Calculation Examples of Theoretical Peak Computational Performance

Next, with reference to FIGS. 7 and 8, calculation examples of theoretical peak computational performance in the case where the tasks of the pair Pi are fused will be described. With the pairs P1 and P2 identified based on the task flow 600 as examples, calculation examples of theoretical peak computational performance in a case where the tasks of the pairs P1 and P2 are fused will be described.

The B/F ratio of hardware that executes the target program 500 is “0.4”, and the double-precision computational performance of hardware is “3000 GFLOPS”. The number of registers included in the hardware that executes the target program 500 is “16”.

First, with reference to FIG. 7, a case will be described in which theoretical peak computational performance in the case where the tasks of the pair P1 (task1 and task2) are fused is calculated.

FIG. 7 is an explanatory diagram illustrating a calculation example of theoretical peak computational performance (part 1). In FIG. 7, the description 501 and the description 502 in the target program 500 (see FIG. 5) are illustrated. The description 501 corresponds to task1. The description 502 corresponds to task2. A calculation example 700 indicates a calculation example of theoretical peak computational performance of each task of the pair P1 (task1 and task2) and theoretical peak computational performance in the case where the tasks of the pair P1 (task1 and task2) are fused.

A case in which theoretical peak computational performance of each task of the pair P1 (task1 and task2) is calculated will be described.

In task1, computation of “A [i][j]+=B [i][j]+C [i][j]” is performed. Consequently, in task1, each of A [i][j], B [i][j], and C [i][j] are read, and the number of times of load is “3”. Since B [i][j] and C [i][j] are added to A [i][j] in task1, the number of computations is “2”. Since arrays A to F are all double-type arrays, the size is “8 bytes”.

In task1, data of 3*8 bytes is read by two times of computation. For this reason, the B/F ratio of task1 is “B/F ratio=3*8/2=12”. The B/F ratio of hardware is “0.4”. The double-precision computational performance of hardware is “3000 GFLOPS”. Based on these, the theoretical peak computational performance of task1 is “theoretical peak computational performance=0.4/12*3000=100” from the above formula (1).

In task2, computation of “A [i][j]+=B [i][j]+D[i][j]” is performed. Consequently, in task2, each of A [i][j], B [i][j], and D[i][j] are read, and the number of times of load is “3”. Since B [i][j] and D[i][j] are added to A [i][j] in task2, the number of computations is “2”.

In task2, data of 3*8 bytes is read by two times of computation. For this reason, the B/F ratio of task2 is “B/F ratio=3*8/2=12”. The B/F ratio of hardware is “0.4”. The double-precision computational performance of hardware is “3000 GFLOPS”. Based on these, the theoretical peak computational performance of task2 is “theoretical peak computational performance=0.4/12*3000=100” from the above formula (1).

Next, a case will be described in which theoretical peak computational performance in the case where the tasks of the pair P1 (task1 and task2) are fused is calculated.

When the tasks of the pair P1 (task1 and task2) are fused, the computation of “A [i][j]+=B [i][j]+D[i][j]” (second time) is performed after the computation of “A [i][j]+=B [i][j]+C [i][j]” (first time) is performed.

Since each of A [i][j], B [i][j], and C [i][j] are read in the first computation, the number of times of load is “3”. Since B [i][j] and C [i][j] are added to A [i][j] in the first computation, the number of computations is “2”.

On the other hand, since the result of the first computation is held in the task, A [i][j] does not have to be read in the second computation. Similarly, since B [i][j] that has already been read may be reused, B [i][j] does not have to be read in the second computation. For this reason, only D[i][j] is read in the second computation, and the number of times of load is “1”. Since B [i][j] and D[i][j] are added to A [i][j] in the second computation, the number of computations is “2”.

As a result, the number of times of load in the case where the tasks of the pair P1 (task1 and task2) are fused is “4”, and the number of computations is “4”. When the tasks of the pair P1 (task1 and task2) are fused, data of 4*8 bytes is read by four times of computation.

Consequently, the B/F ratio in the case where the tasks of the pair P1 (task1 and task2) are fused is “B/F ratio=4*8/4=8”. The B/F ratio of hardware is “0.4”. The double-precision computational performance of hardware is “3000 GFLOPS”. Based on these, the theoretical peak computational performance in the case where the tasks of the pair P1 (task1 and task2) are fused is “theoretical peak computational performance=0.4/8*3000=150” from the above formula (1).

Next, with reference to FIG. 8, a case will be described in which theoretical peak computational performance in the case where the tasks of the pair P2 (task1 and task3) are fused is calculated.

FIG. 8 is an explanatory diagram illustrating a calculation example of theoretical peak computational performance (part 2). In FIG. 8, the description 501 and the description 503 in the target program 500 (see FIG. 5) are illustrated. The description 501 corresponds to task1. The description 503 corresponds to task3. A calculation example 800 indicates a calculation example of theoretical peak computational performance of each task of the pair P2 (task1 and task3) and theoretical peak computational performance in the case where the tasks of the pair P2 (task1 and task3) are fused.

A case in which theoretical peak computational performance of each task of the pair P2 (task1 and task3) is calculated will be described. However, since the theoretical peak computational performance of task1 is similar to that in FIG. 7, description thereof will be omitted.

In task3, computation of “E [i][j]-=F [i][j]” is performed. Consequently, in task3, each of E [i][j] and F [i][j] are read, and the number of times of load is “2”. Since F [i][j] is subtracted from E [i][j] in task3, the number of computations is “1”.

In task3, data of 2*8 bytes is read by one time of computation. For this reason, the B/F ratio of task3 is “B/F ratio=2*8/1=16”. The B/F ratio of hardware is “0.4”. The double-precision computational performance of hardware is “3000 GFLOPS”. Based on these, the theoretical peak computational performance of task3 is “theoretical peak computational performance=0.4/16*3000=75” from the above formula (1).

Next, a case will be described in which theoretical peak computational performance in the case where the tasks of the pair P2 (task1 and task3) are fused is calculated.

When the tasks of the pair P2 (task1 and task3) are fused, the computation of “E [i][j]-=F [i][j]” (second time) is performed after the computation of “A [i][j]+=B [i][j]+C [i][j]” (first time) is performed.

Since each of A [i][j], B [i][j], and C [i][j] are read in the first computation, the number of times of load is “3”. Since B [i][j] and C [i][j] are added to A [i][j] in the first computation, the number of computations is “2”.

Since each of E [i][j] and F [i][j] is read in the second computation, the number of times of load is “2”. Since F [i][j] is subtracted from E [i][j] in the second computation, the number of computations is “1”.

As a result, the number of times of load in the case where the tasks of the pair P2 (task1 and task3) are fused is “5”, and the number of computations is “3”. When the tasks of the pair P2 (task1 and task3) are fused, data of 5*8 bytes is read by three times of computation.

Consequently, the B/F ratio in the case where the tasks of the pair P2 (task1 and task3) are fused is “B/F ratio=5*8/3 ˜ 13.3”. The B/F ratio of hardware is “0.4”. The double-precision computational performance of hardware is “3000 GFLOPS”. Based on these, the theoretical peak computational performance in the case where the tasks of the pair P2 (task1 and task3) are fused is “theoretical peak computational performance=0.4/13.3*3000˜ 90.2” from the above formula (1).

The determination unit 405 determines a fusion target pair from the identified pairs P1 and P2 based on the calculated theoretical peak computational performance of the pairs P1 and P2. When the theoretical peak computational performances of the pairs P1 and P2 are compared with each other, the theoretical peak computational performance of the pair P1 is higher than the theoretical peak computational performance of the pair P2. In this case, for example, the determination unit 405 determines, as the fusion target pair, the pair P1 having the highest calculated theoretical peak computational performance from the pairs P1 and P2.

With respect to the determined fusion target pair P1, the fusion unit 406 determines whether the theoretical peak computational performance of the fusion target pair P1 is equal to or lower than the highest theoretical peak computational performance of the theoretical peak computational performances of the tasks of the fusion target pair P1 (task1 and task2). The theoretical peak computational performances of the tasks (task1 and task2) are both “100”.

For this reason, the highest theoretical peak computational performance of the theoretical peak computational performances of the tasks (task1 and task2) is “100”. The theoretical peak computational performance of the fusion target pair P1 is “150”. Consequently, the fusion unit 406 determines that the theoretical peak computational performance of the fusion target pair P1 is higher than the highest theoretical peak computational performance of the theoretical peak computational performances of the tasks of the fusion target pair P1 (task1 and task2).

The fusion unit 406 determines whether the number of registers to be used in the case where the tasks of the fusion target pair P1 (task1 and task2) are fused exceeds the number of registers included in hardware. The number of registers to be used in the case where the tasks of the fusion target pair P1 (task1 and task2) are fused is “4” since the number of times of load is “4”.

The number of registers included in hardware is “16”. For this reason, the fusion unit 406 determines that the number of registers to be used in the case where the tasks of the fusion target pair P1 (task1 and task2) are fused does not exceed the number of registers included in hardware. In this case, the fusion unit 406 fuses the tasks of the fusion target pair P1 (task1 and task2) in the target program 500.

### Fusion Example of Tasks

Next, with reference to FIG. 9, a fusion example of tasks will be described. The case where the tasks of the fusion target pair P1 (task1 and task2) in the target program 500 are fused will be described as an example.

FIG. 9 is an explanatory diagram illustrating a fusion example of tasks. In FIG. 9, description 901 corresponds to the task after fusion (task1+task2) in which the tasks of the fusion target pair P1 (task1 and task2) are fused in the target program 500. In the description 901, the two tasks of the fusion target pair P1 (task1 and task2) are collectively treated as one task.

Since, by fusing task1 and task2, A [i][j] and B [i][j] may be reused in the task after fusion (task1+task2) and the number of times of load is reduced as compared with that before the fusion, improvement in the performance of the target program 500 may be expected.

### Update Example of Task Flow

Next, with reference to FIG. 10, an update example of the task flow 600 will be described. An update example of the task flow 600 will be described with the case where the tasks of the fusion target pair P1 (task1 and task2) are fused as an example.

FIG. 10 is an explanatory diagram illustrating an update example of the task flow. In FIG. 10, when the tasks of the fusion target pair P1 (task1 and task2) are fused, the fusion unit 406 updates the task flow 600.

For example, the fusion unit 406 generates a node 1001 representing task1′ into which task1 and task2 of the fusion target pair P1 are grouped (task after fusion). Next, the fusion unit 406 determines whether the position of the node 1001 in the task flow 600 is set at the position of the node 601 representing task1 or at the position of the node 602 representing task2 so that the dependency relationship between tasks is satisfied.

There is no dependency relationship to be considered when the position of the node 1001 is determined. For this reason, for example, the fusion unit 406 updates the task flow 600 by setting the position of the node 1001 in the task flow 600 at the position of the node 602 representing task2.

Consequently, task1′ (task after fusion) is incorporated into the task flow 600, and there is a case where the task is selected as the first task or the second task and is further fused with another task when pairs of tasks that may be fused are identified. For example, task1′ is selected as the first task, task3 after task1′ is selected as the second task, and it is determined whether task1′ and task3 are to be fused.

### (Task Tuning Processing Procedure of Information Processing Device 101)

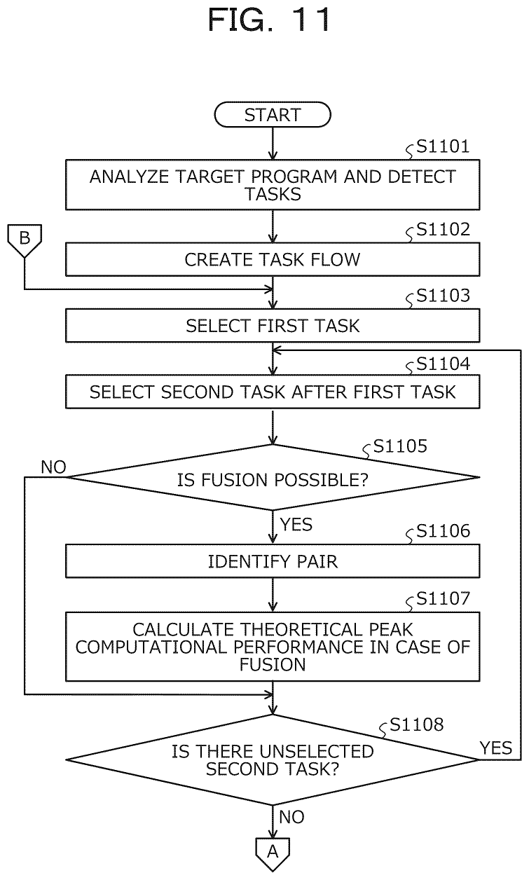

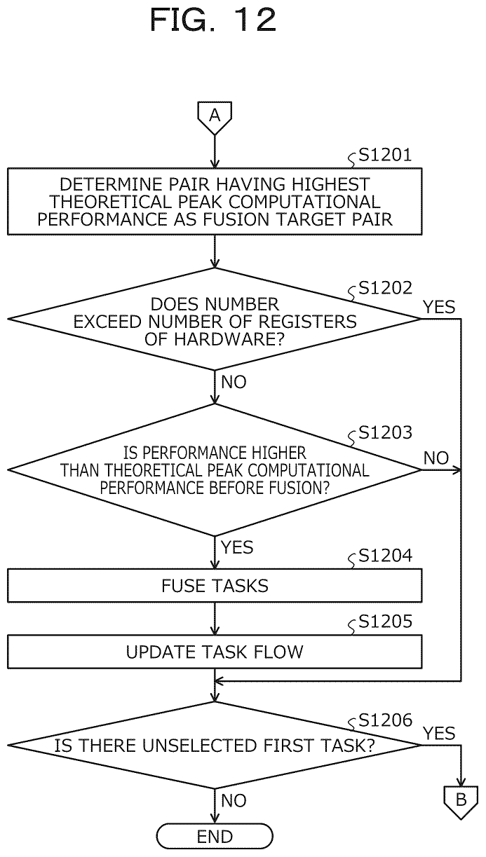

Next, with reference to FIGS. 11 and 12, a task tuning processing procedure of the information processing device 101 will be described. For example, the task tuning processing of the information processing device 101 may be executed when the target program is accepted or when an instruction to execute the target program is accepted.

FIG. 11 and FIG. 12 are flowcharts illustrating an example of the task tuning processing procedure of the information processing device 101. In the flowchart of FIG. 11, the information processing device 101 analyzes the target program and detects tasks (step S1101). Next, the information processing device 101 creates a task flow based on the dependency relationship between detected tasks (step S1102).

The information processing device 101 selects an unselected first task that has not been selected from the top of the created task flow (step S1103). Next, the information processing device 101 selects, from the task flow, an unselected second task that has not been selected after the selected first task (step S1104).

The information processing device 101 determines whether the selected first task and second task may be fused based on the dependency relationship between tasks (step S1105). When the first task and the second task may not be fused (step S1105: No), the information processing device 101 proceeds to step S1108.

On the other hand, when the first task and the second task may be fused (step S1105: Yes), the information processing device 101 identifies the pair Pi of the selected first task and second task (step S1106). The information processing device 101 calculates theoretical peak computational performance in the case where the tasks of the pair Pi are fused based on the B/F ratio in the case where the tasks of the identified pair Pi are fused, the B/F ratio of hardware, and the computational performance of hardware (step S1107).

Next, the information processing device 101 determines whether there is an unselected second task that is after the selected first task and that has not been selected (step S1108). When there is an unselected second task (step S1108: Yes), the information processing device 101 returns to step S1104.

On the other hand, when there is no unselected second task (step S1108: No), the information processing device 101 proceeds to step S1201 illustrated in FIG. 12.

In the flowchart of FIG. 12, first, the information processing device 101 determines, as the fusion target pair, a pair having the highest calculated theoretical peak computational performance from the identified pairs P1 to Pn (step S1201). Next, the information processing device 101 determines whether the number of registers to be used in the case where the tasks of the fusion target pair are fused together exceeds the number of registers included in hardware (step S1202).

When the number exceeds the number of registers included in hardware (step S1202: Yes), the information processing device 101 proceeds to step S1206. On the other hand, when the number does not exceed the number of registers included in hardware (step S1202: No), the information processing device 101 determines whether the theoretical peak computational performance of the fusion target pair is higher than the theoretical peak computational performance before fusion (step S1203).

For example, the information processing device 101 calculates theoretical peak computational performance for each task of the fusion target pair. When the theoretical peak computational performance of the fusion target pair is higher than the theoretical peak computational performance of any task of the fusion target pair, the information processing device 101 determines that the performance is higher than the theoretical peak computational performance before fusion. When the theoretical peak computational performance of the fusion target pair is equal to or lower than the highest theoretical peak computational performance of the theoretical peak computational performances of the tasks of the fusion target pair, the information processing device 101 determines that the performance is equal to or lower than the theoretical peak computational performance before fusion.

When the performance is equal to or lower than the theoretical peak computational performance before fusion (step S1203: No), the information processing device 101 proceeds to step S1206. On the other hand, when the performance is higher than the theoretical peak computational performance before fusion (step S1203: Yes), the information processing device 101 fuses the tasks of the fusion target pair in the target program (step S1204).

The information processing device 101 updates the task flow so that the dependency relationship between tasks is satisfied (step S1205). Next, the information processing device 101 determines whether there is an unselected first task that has not been selected from the task flow (step S1206). When there is an unselected first task (step S1206: Yes), the information processing device 101 returns to step S1103 illustrated in FIG. 11. On the other hand, when there is no unselected first task (step S1206: No), the information processing device 101 ends the series of processing in the present flowchart.

Consequently, the information processing device 101 may improve the performance of the target program by grouping tasks, the performance of which is expected to be improved by task fusion, into one task. The information processing device 101 may execute the target program in which the tasks of the fusion target pair are fused.

As has been described, according to the information processing device 101 according to the embodiment, tasks may be detected by analyzing the target program, and pairs of tasks that may be fused into one task among the detected tasks may be identified based on the dependency relationship between detected tasks. According to the information processing device 101, theoretical peak computational performance in the case where the tasks of the pair Pi are fused may be calculated for each identified pair Pi included in the pairs P1 to Pn based on the B/F ratio in the case where the tasks of the pair Pi are fused (first value), the B/F ratio of hardware that executes the target program (second value), and the computational performance of hardware. According to the information processing device 101, a fusion target pair may be determined from the pairs P1 to Pn based on the calculated theoretical peak computational performance, and the tasks of the determined fusion target pair in the target program may be fused.

Consequently, the information processing device 101 may achieve speeding up of the target program by automatic tuning of the target program tailored for the characteristics of the executing hardware (for example, the information processing device 101). For example, by grouping, into one task, tasks whose performance is expected to be improved by task fusion, the information processing device 101 may reuse information in the task, reduce an extra number of times of load, and improve the performance of the target program.

According to the information processing device 101, theoretical peak computational performance of each task may be calculated based on the B/F ratio of each task of the determined fusion target pair (third value), the B/F ratio of hardware, and the computational performance of hardware. According to the information processing device 101, tasks of a fusion target pair may be chosen not to be fused when the theoretical peak computational performance of the fusion target pair is equal to or lower than the highest theoretical peak computational performance of the calculated theoretical peak computational performances of the tasks.

Consequently, in the case where improvement in performance by task fusion is not expected, the information processing device 101 may choose not to fuse the tasks of the fusion target pair and reduce uselsss processing and suppress an increase in processing load.

According to the information processing device 101, it may be chosen not to fuse the tasks of the fusion target pair when the number of registers to be used in the case where the tasks of the determined fusion target pair are fused exceeds the number of registers included in hardware.

Consequently, the information processing device 101 may avoid a situation in which the scale of one task is too large and a wait occurs in the processing in the task due to a shortage of registers.

According to the information processing device 101, a task flow may be created in which detected tasks are arranged in an execution order that satisfies the dependency relationship between tasks based on the dependency relationship between detected tasks and the tasks having the dependency relationship are coupled to each other. According to the information processing device 101, pairs of tasks that may be fused into one task among the detected tasks may be identified based on the created task flow. For example, the information processing device 101 selects an unselected first task that has not been selected from the top of the task flow, selects, from the task flow, a second task that is after the selected first task and that may be fused with the first task based on the dependency relationship between tasks, and identifies the pair of the selected first task and second task.

Consequently, the information processing device 101 may efficiently and comprehensively identify pairs of tasks that may be fused into one task.

According to the information processing device 101, in the case where the tasks of the fusion target pair are fused, the task flow may be updated by setting the position of the task after fusion into which the first task and the second task of the fusion target pair are grouped in the task flow at the position of either the first task or the second task so that the dependency relationship between tasks is satisfied. According to the information processing device 101, pairs of tasks that may be fused into one task may be identified based on the updated task flow.

Consequently, the information processing device 101 may identify pairs of tasks that may be fused by using the updated task flow without re-creating the task flow from scratch.

According to the information processing device 101, a pair having the highest calculated theoretical peak computational performance may be determined as the fusion target pair from the identified pairs P1 to Pn.

Consequently, the information processing device 101 may fuse the tasks of the pair whose performance is most expected to be improved by task fusion and efficiently improve the performance of the target program.

According to the information processing device 101, theoretical peak computational performance in the case where the tasks of the pair Pi are fused may be calculated by multiplying, by the computational performance of hardware, the value obtained by dividing the B/F ratio of hardware (second value) by the B/F ratio in the case where the tasks of the pair Pi are fused (first value).

Consequently, the information processing device 101 may obtain theoretical peak computational performance in consideration of how much the computational performance of hardware is brought out from the closeness between the B/F ratio in the case where the tasks of the pair Pi are fused and the B/F ratio of hardware.

According to the information processing device 101, the target program in which the tasks of the fusion target pair are fused may be executed.

Consequently, the information processing device 101 may execute the target program in a shorter time than before the tuning.

From the above, according to the task tuning program and task tuning method according to the present embodiment, performance of a program may be improved and speeding up of the program may be achieved. According to the task tuning program and task tuning method, for example, by grouping tasks, the performance of which is expected to be improved, into one task, processing in the task may be efficiently executed and the performance of an HPC program may be improved. According to the task tuning program and task tuning method, by fusing a plurality of tasks and grouping them into one task, generation of a large number of tasks having low theoretical peak computational performance may be suppressed, overhead for task generation may be reduced, and the performance of an HPC program may be efficiently improved.

The task tuning method described in the present embodiment may be realized by executing a program prepared in advance on a computer such as a personal computer or a workstation. The present task tuning program is recorded in a computer-readable recording medium such as a hard disk, a flexible disk, a CD-ROM, a DVD, or a USB memory, and is executed by being read from the recording medium by the computer. The present task tuning program may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a task tuning program for causing a computer to execute a process comprising:
analyzing a program and detecting tasks;
identifying pairs of tasks that are able to be fused into one task among the tasks that have been detected based on a dependency relationship between the tasks that have been detected;
for each of the pairs that have been identified, calculating theoretical peak computational performance in a case where tasks of the pairs are fused based on a first value that represents a memory bandwidth per computational performance in a case where tasks of the pairs are fused, a second value that represents a memory bandwidth per computational performance of hardware that executes the program, and computational performance of the hardware;
determining a fusion target pair from the pairs that have been identified based on the theoretical peak computational performance that has been calculated; and
fusing tasks of the fusion target pair that has been determined in the program.

2. The non-transitory computer-readable recording medium according to claim 1, wherein
the computer is caused to execute a process of
based on a third value that represents a memory bandwidth per computational performance of each task of the fusion target pair that has been determined, the second value, and computational performance of the hardware, calculating theoretical peak computational performance of the each task, and
in the fusing,
tasks of the fusion target pair are not fused when theoretical peak computational performance of the fusion target pair is equal to or lower than highest theoretical peak computational performance of calculated theoretical peak computational performances of the each task.

3. The non-transitory computer-readable recording medium according to claim 1, wherein
in the fusing,
tasks of the fusion target pair are not fused when a number of registers to be used in a case where tasks of the fusion target pair that has been determined are fused exceeds a number of registers included in the hardware.

4. The non-transitory computer-readable recording medium according to claim 1, wherein
the computer is caused to execute a process of
based on a dependency relationship between the tasks that have been detected, creating a task flow in which the tasks that have been detected are arranged in an execution order that satisfies the dependency relationship and tasks that have the dependency relationship are coupled to each other, and
in the identifying,
pairs of tasks that are able to be fused into one task among the tasks that have been detected are identified based on the task flow that has been created.

5. The non-transitory computer-readable recording medium according to claim 4, wherein
in the identifying,
an unselected first task that has not been selected is selected from a top of the task flow,
a second task that is after the first task that has been selected and that is able to be fused with the first task is selected from the task flow based on the dependency relationship, and
a pair of the first task and the second task that have been selected is identified.

6. The non-transitory computer-readable recording medium according to claim 5, wherein
in a case where tasks of the fusion target pair are fused, the task flow is updated by setting a position of a task after fusion into which a first task and a second task of the fusion target pair are grouped in the task flow at a position of either the first task or the second task so that the dependency relationship is satisfied, and
the computer is caused to repeatedly execute the identifying, the calculating, the determining, and the fusing.

7. The non-transitory computer-readable recording medium according to claim 1, wherein
in the determining,
a pair for which the theoretical peak computational performance that has been calculated is highest is determined as the fusion target pair from the pairs that have been identified.

8. The non-transitory computer-readable recording medium according to claim 1, wherein
in the calculating,
the theoretical peak computational performance is calculated by multiplying, by computational performance of the hardware, a value obtained by dividing the second value by the first value.

9. The non-transitory computer-readable recording medium according to claim 1, wherein the computer is caused to execute a process of
executing the program in which tasks of the fusion target pair are fused.

10. A task tuning method for causing a computer to execute a process comprising:
analyzing a program and detecting tasks;
identifying pairs of tasks that are able to be fused into one task among the tasks that have been detected based on a dependency relationship between the tasks that have been detected;
for each of the pairs that have been identified, calculating theoretical peak computational performance in a case where tasks of the pairs are fused based on a first value that represents a memory bandwidth per computational performance in a case where tasks of the pairs are fused, a second value that represents a memory bandwidth per computational performance of hardware that executes the program, and computational performance of the hardware;
determining a fusion target pair from the pairs that have been identified based on the theoretical peak computational performance that has been calculated; and
fusing tasks of the fusion target pair that has been determined in the program.
